(19) United States
(12) Patent Application Publication
(10) Pub. No.: US 2024/0330333 A1
(43) Pub. Date: Oct. 3, 2024

(54) AUTOMATICALLY MODIFYING COMMUNICATION CONTENT USING ARTIFICIAL INTELLIGENCE TECHNIQUES

(71) Applicant: International Business Machines Corporation, Armonk, NY (US)

(72) Inventors: Sanket Jain, GURGAON (IN); Sukumar Beri, Noida (IN); Prosenjit Dan, Kolkata (IN); Jatinder S. Joshi, GURGAON (IN); Pinaki Chattopadhyay, Bangalore (IN)

(21) Appl. No.: 18/128,613

(22) Filed: Mar. 30, 2023

(51) Int. Cl. G06F 16/332; G06F 40/35; G06F 40/56

(52) U.S. Cl. CPC G06F 16/3329; G06F 40/35; G06F 40/56

(57) ABSTRACT

Methods, systems, and computer program products for automatically modifying communication content using artificial intelligence techniques are provided herein. A computer-implemented method includes identifying one or more portions of communication content within a group communication session to be modified by processing the communication content and one or more items of contextual information associated with the group communication session; generating at least one item of modified communication content related to at least a portion of the one or more identified portions of communication content by processing the one or more identified portions of communication content using one or more artificial intelligence techniques; and performing one or more automated actions based at least in part on the at least one item of modified communication content.

### BACKGROUND

The present application generally relates to information technology and, more particularly, to data processing techniques. More specifically, group communication sessions often involve participation from individuals associated with different geographic locations and/or backgrounds. Accordingly, confusion and/or lack of clarity can arise, and such issues can be exacerbated as the number of individuals participating in the given group communication session increases.

### SUMMARY

In at least one embodiment, techniques for automatically modifying communication content using artificial intelligence techniques are provided.

An example computer-implemented method can include identifying one or more portions of communication content within a group communication session to be modified by processing the communication content and one or more items of contextual information associated with the group communication session. The method also includes generating at least one item of modified communication content related to at least a portion of the one or more identified portions of communication content by processing the one or more identified portions of communication content using one or more artificial intelligence techniques. Additionally, the method includes performing one or more automated actions based at least in part on the at least one item of modified communication content.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an example workflow according to an example embodiment of the invention;

FIG. 2 is a diagram illustrating an example workflow according to an example embodiment of the invention;

FIG. 3 is a diagram illustrating example architecture according to an example embodiment of the invention;

FIG. 4 is a diagram illustrating an example workflow for using a transactional analysis framework according to an example embodiment of the invention;

FIG. 5 is a diagram illustrating an example workflow for using a transactional analysis framework according to an example embodiment of the invention;

FIG. 6 is a diagram illustrating an example workflow for using a transactional analysis framework according to an example embodiment of the invention;

FIG. 7 is a diagram illustrating an example workflow for using a transactional analysis framework according to an example embodiment of the invention;

FIG. 8 is a flow diagram illustrating techniques according to an example embodiment of the invention; and

FIG. 9 is a diagram illustrating a computing environment in which at least one embodiment of the invention can be implemented.

### DETAILED DESCRIPTION

As described herein, at least one embodiment includes automatically modifying communication content using artificial intelligence techniques. For example, such an embodiment can include using one or more conversational artificial intelligence techniques to determine and/or identify one or more alternatives to particular communication content (e.g., ambiguous and/or vague content) provided during one or more group communication sessions.

One or more embodiments include utilizing one or more artificial intelligence techniques to identify and replace and/or modify communication content (e.g., audio content and/or written content) within the context of a group communication session. More specifically, such an embodiment includes identifying one or more vague and/or unclear queries and/or responses submitted as part of a group communication session by processing, using one or more artificial intelligence techniques, the queries and responses to associated one or more topics to at least a portion of the queries and/or responses. Additionally, such an embodiment includes identifying at least a portion of the responses that is deviating from the one or more topics associated with at least one corresponding query. Such identification can be carried out, for example, by ranking each response statement based at least in part on the statement's proximity to the one or more topics associated with the at least one corresponding query, and assigning a lower ranking and/or priority to the response statements that are most ambiguous and/or unrelated to the one or more topics. Further, such an embodiment can include clustering similar queries and/or similar responses, and prioritizing modification efforts based at least in part on the determined relevance of the query and/or response to one or more portions of the group communication session.

At least one embodiment can also include outputting one or more modified queries and/or one or more modified query responses to one or more group communication session participants (e.g., in approximately real-time). Additionally, such an embodiment can include generating and outputting at least one recommendation in conjunction with the one or more modified queries and/or one or more modified query responses.

As also detailed herein, one or more embodiments include processing content of a group communication session to identify one or more portions of the session wherein a pause and/or communication break lasting longer than a given and/or predetermined amount of time (e.g., ten seconds) exists. Such an embodiment can additionally include processing one or more portions of communication content preceding the identified pause and/or communication break, and, for each such portion of communication content, determining at least one level of relevance to one or more topics determined to be associated with the portions of communication content. Further, based at least in part on the at least one determined level of relevance, such an embodiment can include automatically modifying at least a portion of the communication content preceding the identified pause and/or communication break, and outputting the modified communication content to one or more users in the group communication session (e.g., the user likely to communicate next in the session, such as a host delaying responding to a query).

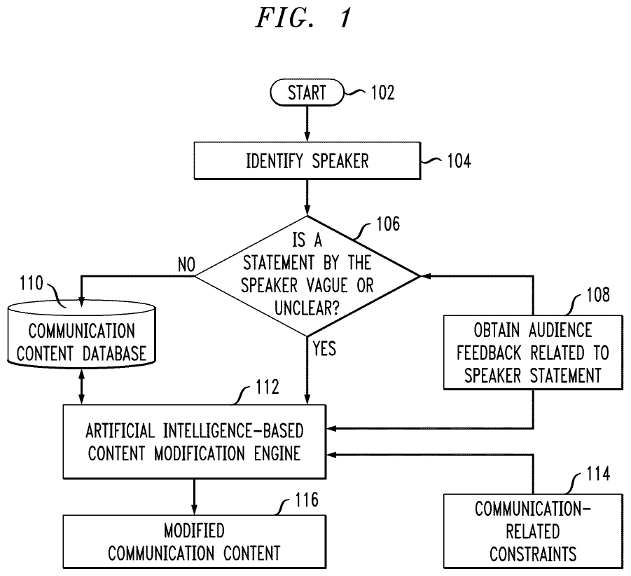

FIG. 1 is a diagram illustrating an example workflow according to an example embodiment of the invention. By way of illustration, FIG. 1 depicts starting the workflow in step 102, and identifying a speaker in a group communication session in step 104. Step 106 includes determining whether a statement by the speaker is vague or unclear. If no (that is, the statement is not vague or unclear), the statement is stored in communication content database 110. If yes (that is, the statement is vague or unclear), the statement is passed to and/or processed by artificial intelligence-based content modification engine 112. Additionally, step 108 includes obtaining audience feedback related to the speaker statement, at least a portion of which is then passed to and/or processed by artificial intelligence-based content modification engine 112. In obtaining audience feedback, one or more embodiments include collecting questions live (e.g., participants can send in questions directly during the meeting(s), conducting a participant poll, etc. Note that when a word can have multiple meanings, at least one embodiment includes representing context from which the word was used and implementing a feedback loop wherein the user (e.g., the speaker) is queried as to which meaning was implied when the user provided that utterance. Similarly, such an embodiment can include obtaining and/or querying audience feedback in approximately real time when a vague statement is being made by the host and/or another audience member.

As depicted in FIG. 1, also provided to and/or processed by artificial intelligence-based content modification engine 112 are one or more communication-related constraints 114, which can include, for example, constraints related to ensuring a flow of speech by the speaker, ensuring a maximum of two modified sentences to be sent to the speaker, etc.

Based at least in part on processing the above-noted inputs, artificial intelligence-based content modification engine 112 generates and outputs modified communication content 116, related to the vague or unclear statement by the speaker. At least one embodiment can include using artificial intelligence techniques such as, for example, at least one tone analyzer, at least one weather application programming interface (API), at least one speech-to-text API, and one or more knowledge graph-related techniques (e.g., transactional analysis framework, analysis of speech (using at least one speech-to-text API), and/or at least one deep reinforcement learning technique. Additionally, such an embodiment can include using at least one softmax function to perform classifications, as there can multiple combinations and/or permutations to be classified. A likelihood score can also be determined for each of the combinations and/or permutations, and the combination and/or permutation with the highest likelihood can be selected.

As noted above and herein, one or more embodiments include identifying, within the context of a group communication session, one or more phrases and/or sentences that are ambiguous or vague, as well as identifying the speaker(s) of such phrases and/or sentences. In such an embodiment, identifying ambiguous or vague communication content can include filtering the content using one or more predetermined ambiguity-creating keywords (e.g., region-specific terms, etc.). Additionally, one or more embodiments include determining the language in which an identified ambiguous or unclear communication content (e.g., one or more words, phrases, sentences, etc.) is spoken. In such an embodiment, generating modified communication content may include translating one or more portions of the ambiguous or unclear communication content.

Further, at least one embodiment includes determining the speed or pace at which a speaker speaks communication content identified as vague or ambiguous (e.g., by using speech-to-text (STT) techniques to determine the current speed of speech and the number of words spoken by the speaker and/or using STT techniques to determine the average speed of speech and the number of words expected to be spoken based at least in part on the audience profile). In such an embodiment, generating modified communication content can include recommending, to the speaker, an ideal speed and/or word limit based at least in part on audience-related variables and/or feedback.

Also, one or more embodiments include monitoring a group communication session and noting when a pause or delay in communication content extends beyond a predetermined limit or threshold (e.g., 10-20 seconds). Upon identification of such a pause or delay, at least one embodiment includes generating and outputting a prompt to one or more participants of the group communication session (e.g., the most recent speaker, a person queried to answer the most recent query, etc.) to speak. However, if the given participant does not follow the prompt, and if the pause or delay continues beyond an additional predetermined limit or threshold (e.g., an additional 10-20 seconds), then such an embodiment includes determining that the preceding communication content can be deemed ambiguous or vague.

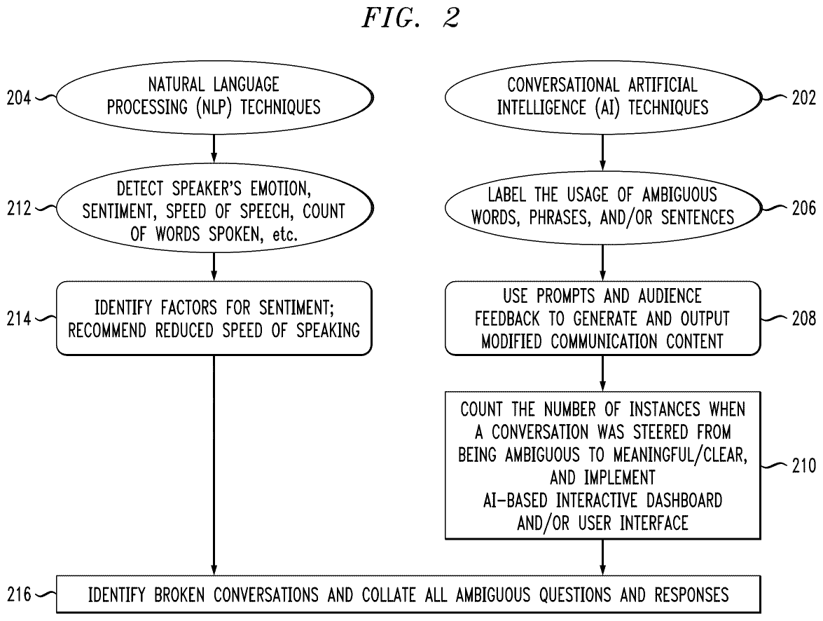

FIG. 2 is a diagram illustrating an example workflow according to an example embodiment of the invention. In connection with data from data sources including communication content (e.g., one or more words, one or more phrases, and/or one or more sentences spoken and/or written by a speaker in a group communication session), audience feedback to speaker content, number of prompts to improve communication content, etc., FIG. 2 depicts conversational artificial intelligence techniques 202 processing at least a portion of such data and natural language processing (NLP) techniques 204 processing at least a portion of such data. At least one embodiment includes using the last conversation and at least one previous conversation between the speaker and at least one person in the audience and applying one or more classification techniques (e.g., a softmax algorithm) to find one or more permutations with a given likelihood (e.g., the highest likelihood).

In connection with using the conversational artificial intelligence techniques 202, step 206 includes labeling, within the communication content, the usage of one or more ambiguous or unclear words, phrases, and/or sentences. Further, step 208 includes using one or more prompts and audience feedback to generate and output modified communication content. Step 210 then includes counting the number of instances when a discussion or conversation was steered from an ambiguous or unclear moment to a meaningful and/or clear moment, and integrating such counts in an artificial intelligence-based interactive dashboard and/or user interface.

In connection with using the NLP techniques 204, step 212 includes detecting, within the communication content, one or more speaker emotions and/or sentiments, the speed of speech, the count of words spoken, etc. Step 214 then includes identifying one or more factors for the detected emotion(s) and/or sentiment, and recommending (to the speaker) a reduced speed of speech. Further, based at least on inputs from step 214 and step 210, step 216 includes identifying one or more broken conversations (wherein consistent communication has ceased and/or delays are increasing in frequency and/or duration), collating all ambiguous or unclear questions and responses.

As detailed herein, one or more embodiments can include using techniques such as, for example, one or more knowledge graphs, at least one transactional analysis framework, one or more speech-to-text APIs, and one or more deep reinforcement learning techniques. By way of example, when a word can have multiple meanings and hence multiple outcomes, at least one embodiment can include applying one or more deep reinforcement learning techniques to assign probability values to each meaning (e.g., based on the relevance of each meaning to a given topic and/or one or more contextual details associated with the group communication session) and rank each outcome. Such an embodiment can further include representing the context from which the word was used and implementing a feedback loop wherein the user/speaker can be queried as to which meaning was implied when s/he issued the word.

Additionally, in one or more embodiments, artificial intelligence techniques can be implemented to accomplish multiple objectives. Such an embodiment can include using at least one softmax function because there can be 3*3=9 combinations (e.g., permutations), preparing at least one likelihood score for each of the nine combinations, and then selecting the option with the highest likelihood (e.g., wherein the likelihood score is between zero and one).

By way of further example, artificial intelligence techniques can be implemented to identify broken conversations and cluster such conversations together for further processing. Also, artificial intelligence techniques can be implemented to analyze questions raised during a group communication session to ensure that the questions are sufficiently clear. Additionally, artificial intelligence techniques can be implemented to determine at least one desired delay or time gap by a speaker in responding to a question (e.g., 5-10 seconds) before deeming the question to be vague and/or ambiguous. Further, artificial intelligence techniques can be implemented to process a statement and/or other communication content by someone or more speakers in a group communication session and assess clarity and/or ambiguity based at least in part on statement context.

One or more embodiments can also include (such as described in connection with step 216 in FIG. 2) identifying and tagging one or more statements determined to commonly lead to a broken path and/or communication (e.g., because such statements are sufficiently unlikely to lead to a sufficient answer), and collating corresponding broken conversations for use as at least part of a training dataset for training artificial intelligence techniques that are to be implemented to identify broken paths and/or communications.

In determining levels of ambiguity and/or vagueness of communication content, at least one embodiment can include selecting samples from one or more portions of at least one group communication session, and identifying one or more themes in relation to the topic(s) being discussed (e.g. sports, foods, holidays, etc.). By way merely or illustration, assume that sports is the theme in question. Such an embodiment can include using one or more NLP techniques to prepare a score for each of multiple sports, then assigning a vector (x, y) to each of the portions of communication content. One or more embodiments can include carrying out such tasks as a multi-dimensional problem, as each topic will have its own dimension.

Additionally, such an embodiment can include assigning a score for each of the multiple sports based on the above-noted vector assignment. Further, each of the portions of communication content can be ranked based on its proximity to the central topic under discussion (e.g., wherein a higher ranking and/or weightage indicates higher deviance from the topic and/or increased amounts of vagueness relative to the topic).

As further detailed herein, one or more embodiments can include implementing at least one at least one transactional analysis framework. By way of example, when there are too many crossed transactions, then such an embodiment includes analyzing Entity1-to-Entity2 conversations and recommending the next dialog or conversation be an Entity2-to-Entity1 exchange to render the conversation a parallel conversation. Similarly, if an exchange is of the type Entity1-to-Entity3, then the next exchange that should be encouraged should be Entity3-to-Entity1. Accordingly, at least one embodiment includes considering a smooth flowing conversation between a speaker and at least one person or participant in the audience as a parallel transaction, and all other conversations are considered to be crossed transactions which can potentially result in a broken conversation.

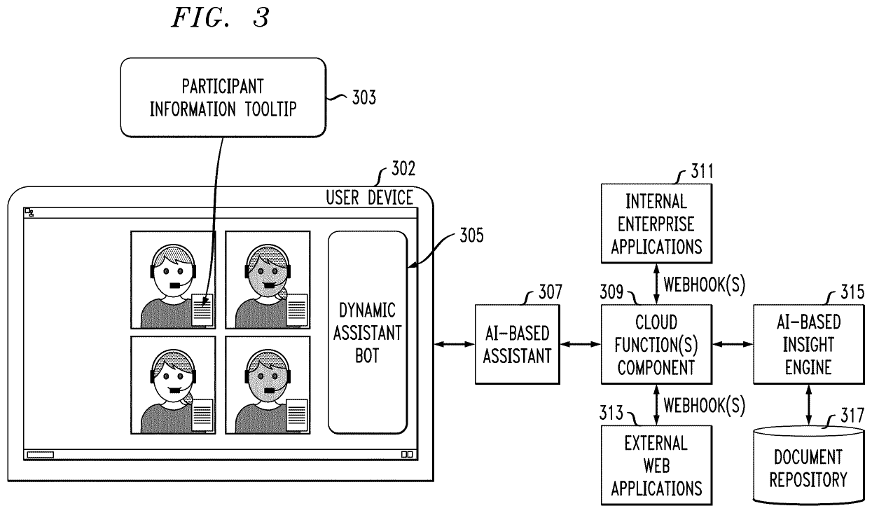

FIG. 3 is a diagram illustrating example architecture according to an example embodiment of the invention. By way of illustration, FIG. 3 depicts user device 302, which can display multiple communication session participants and respective participant information tooltips 303 which can display participant information such as, for example, location, local weather, department, role, local time, etc. Also executing as part of user device 302 is dynamic assistant bot 305, which fetches information related to at least a portion of the participants (e.g., cultural information, preferences, etc.) and communication session agenda information while the communication session is in progress. Such information from participant information tooltip 303 and dynamic assistant bot 305 are processed by at least one artificial intelligence-based assistant 307, which interacts with cloud function(s) component 309 to carry out one or more actions in connection with one or more internal enterprise applications 311 and/or one or more external web applications 313 (using one or more webhooks). Cloud function(s) component 309 also provides input(s) to artificial intelligence-based insight engine 315, which processes such input(s) (e.g., unstructured documents) and identifies one or more patterns, one or more trends and/or one or more actionable insights that can drive better decision-making, and stores at least a portion of the same in document repository 317.

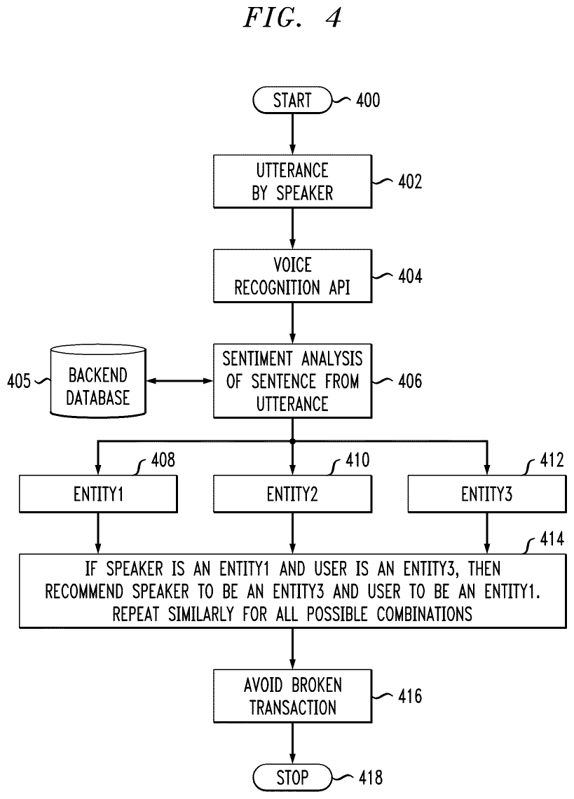

FIG. 4 is a diagram illustrating an example workflow for using a transactional analysis framework according to an example embodiment of the invention. Specifically, FIG. 4 depicts an example workflow for encouraging conversation to avoid a broken transaction. Step 400 includes starting the workflow, step 402 includes capturing an utterance by a speaker, and step 404 includes processing at least a portion of the utterance using at least one voice recognition API. Based at least in part on the results of step 404 as well as information derived from backend database 405, step 406 includes performing sentiment analysis of at least one sentence from the utterance and categorizing one or more portions of the at least one sentence as being attributed to an first type of entity (Entity1) 408, a second type of entity (Entity2) 410, and a third type of entity (Entity3) 412, wherein characteristics of the various types of entity are predetermined and/or established. If the speaker of the utterance is determined to be categorized as an Entity1 and the user (e.g., audience participant in question) is determined to be categorized as an Entity3, for example, then step 414 includes recommending the subsequent speaker assume the role of Entity3 and the subsequent user assume the role of Entity1. Step 414 can also include repeating the above-noted actions for all possible communication arrangement combinations. Based on the combinations determined and analyzed in step 414, step 416 includes selecting the most likely combination and avoiding a broken transaction (also referred to herein as a broken conversation) and step 418 includes stopping the workflow.

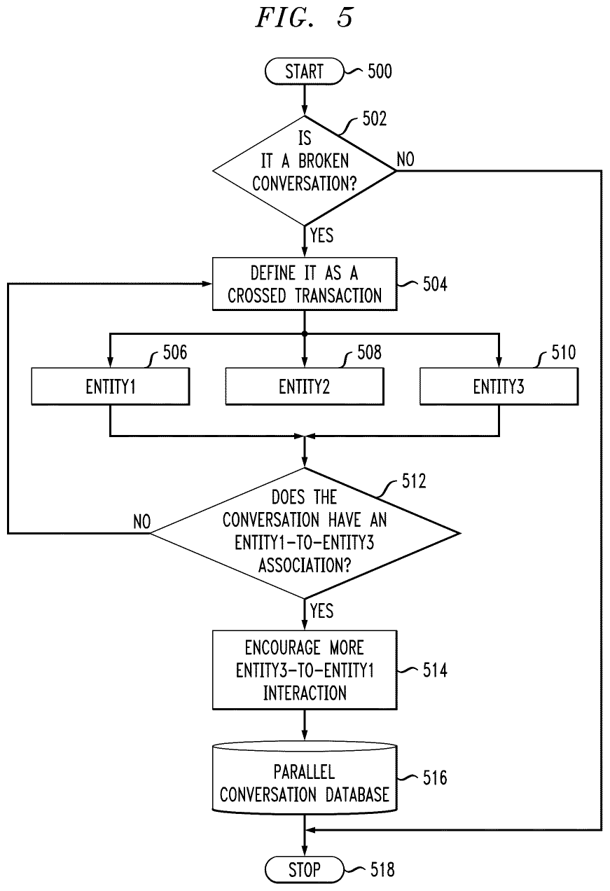

FIG. 5 is a diagram illustrating an example workflow for using a transactional analysis framework according to an example embodiment of the invention. Step 500 includes starting the workflow and step 502 includes determining whether a given conversation is a broken conversation. If no, then the workflow stops at step 518. If yes (that is, the given conversation is a broken conversation), then step 504 includes defining the conversation as a crossed transaction involving two or more of a predefined first type of entity (Entity1) 506, a predefined second type of entity (Entity2) 508, and a predefined third type of entity (Entity3) 510. Based at least in part on the outcome of step 504, step 512 includes determining whether the conversation has an Entity1-to-Entity3 association. If no, then the workflow returns to step 504. If yes (that is, the conversation has an Entity1-to-Entity3 association), then step 514 includes encouraging more Entity3-to-Entity1 interaction, storing at least a portion of data related to such encouragement into parallel conversation database 516, and stopping the workflow in step 518.

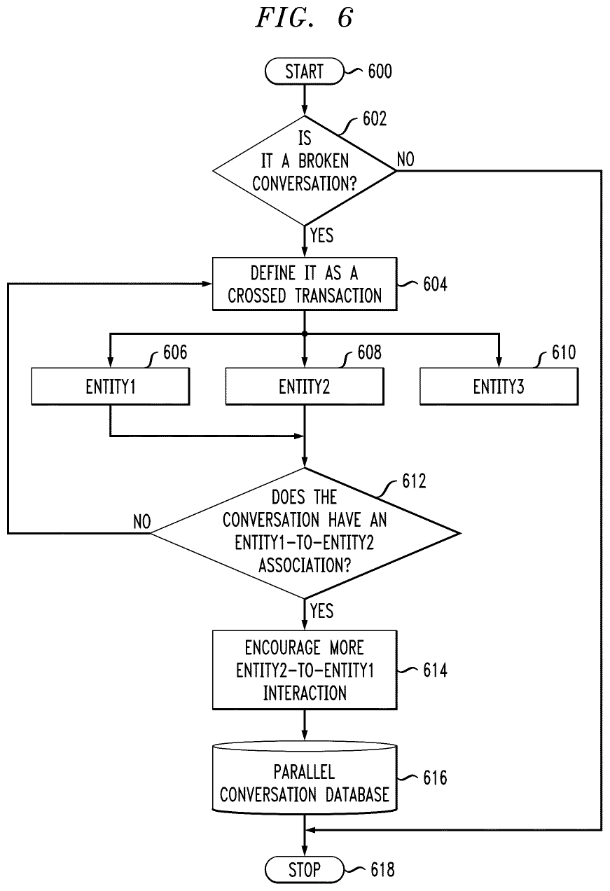

FIG. 6 is a diagram illustrating an example workflow for using a transactional analysis framework according to an example embodiment of the invention. Step 600 includes starting the workflow and step 602 includes determining whether a given conversation is a broken conversation. If no, then the workflow stops at step 618. If yes (that is, the given conversation is a broken conversation), then step 604 includes defining the conversation as a crossed transaction involving two or more of the predefined first type of entity (Entity1) 606, the predefined second type of entity (Entity2) 608, and the predefined third type of entity (Entity3) 610. Based at least in part on the outcome of step 604, step 612 includes determining whether the conversation has an Entity1-to-Entity2 association. If no, then the workflow returns to step 604. If yes (that is, the conversation has an Entity1-to-Entity2 association), then step 614 includes encouraging more Entity2-to-Entity1 interaction, storing at least a portion of data related to such encouragement into parallel conversation database 616, and stopping the workflow in step 618.

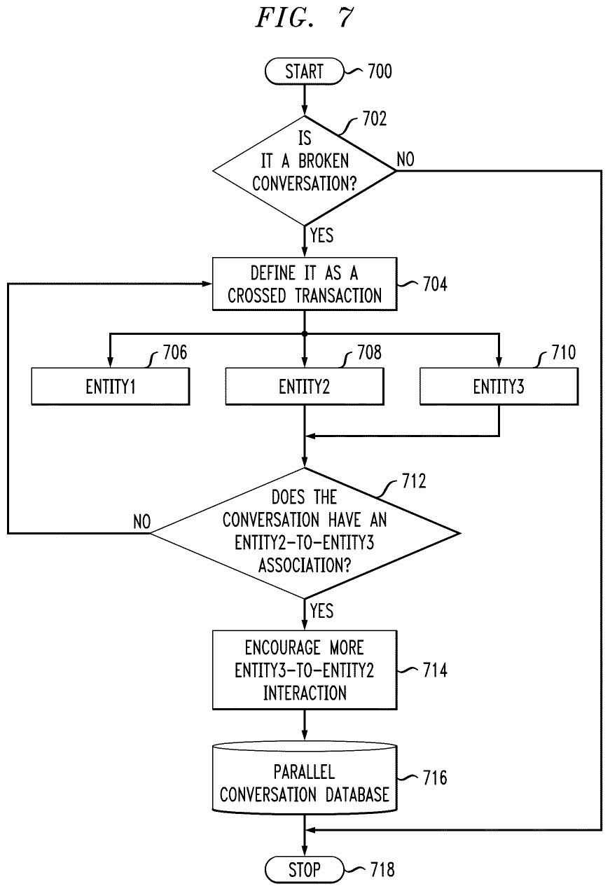

FIG. 7 is a diagram illustrating an example workflow for using a transactional analysis framework according to an example embodiment of the invention. Step 700 includes starting the workflow and step 702 includes determining whether a given conversation is a broken conversation. If no, then the workflow stops at step 718. If yes (that is, the given conversation is a broken conversation), then step 704 includes defining the conversation as a crossed transaction involving two or more of the predefined first type of entity (Entity1) 706, the predefined second type of entity (Entity2) 708, and the predefined third type of entity (Entity3) 710. Based at least in part on the outcome of step 704, step 712 includes determining whether the conversation has an Entity2-to-Entity3 association. If no, then the workflow returns to step 704. If yes (that is, the conversation has an Entity2-to-Entity3 association), then step 714 includes encouraging more Entity3-to-Entity2 interaction, storing at least a portion of data related to such encouragement into parallel conversation database 716, and stopping the workflow in step 718.

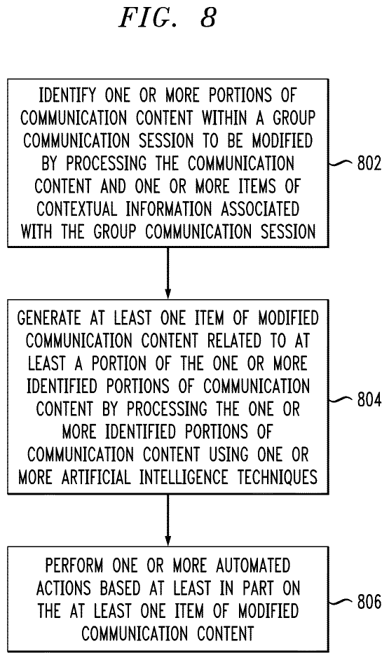

FIG. 8 is a flow diagram illustrating techniques according to an embodiment of the present invention. Step 802 includes identifying one or more portions of communication content within a group communication session to be modified by processing the communication content and one or more items of contextual information associated with the group communication session. In at least one embodiment, identifying one or more portions of communication content within a group communication session to be modified includes determining, for each of multiple portions of the communication content, at least one degree of proximity relative to at least one topic associated with the communication content. Additionally or alternatively, identifying one or more portions of communication content within a group communication session to be modified can include processing the communication content against one or more predetermined factors associated with ambiguous communication content, wherein the one or more predetermined factors include at least one of usage of one or more words being associated with multiple meanings, speed of speech exceeding a predetermined threshold, and usage of a number of words exceeding a predetermined threshold amount.

Also, in at least one embodiment, identifying one or more portions of communication content within a group communication session to be modified can include comparing one or more amplitude of sound associated with the communication content against at least one predetermined threshold. Further, identifying one or more portions of communication content within a group communication session to be modified can include filtering the communication content using one or more predetermined keywords associated with ambiguity.

Step 804 includes generating at least one item of modified communication content related to at least a portion of the one or more identified portions of communication content by processing the one or more identified portions of communication content using one or more artificial intelligence techniques. In one or more embodiments, processing the one or more identified portions of communication content using one or more artificial intelligence techniques includes processing the one or more identified portions of communication content using one or more natural language processing techniques. In such an embodiment, using one or more natural language processing techniques can include using one or more natural language processing techniques in conjunction with at least one chatbot.

Additionally or alternatively, processing the one or more identified portions of communication content using one or more artificial intelligence techniques can include processing the one or more identified portions of communication content using one or more deep reinforcement learning techniques.

Also, in one or more embodiments, generating at least one item of modified communication content includes using at least one knowledge graph in conjunction with the one or more artificial intelligence techniques, wherein using the at least one knowledge graph includes adjusting weights of one or more nodes of the at least one knowledge graph based at least in part on one or more speaker sentiments associated with the one or more identified portions of communication content. Additionally or alternatively, generating at least one item of modified communication content can include assigning one or more vectors to the one or more identified portions of communication content and ranking, using the one or more vectors, each of the one or more identified portions of communication content based at least in part on proximity to one or more topics associated with the group communication session.

Step 806 includes performing one or more automated actions based at least in part on the at least one item of modified communication content. In at least one embodiment, performing one or more automated actions includes automatically outputting the at least one item of modified communication content to one or more participants in the group communication session. Additionally or alternatively, performing one or more automated actions can include automatically training at least a portion of the one or more artificial intelligence techniques using feedback related to the at least one item of modified communication content.

Also, in one or more embodiments, software implementing the techniques depicted in FIG. 8 can be provided as a service in a cloud environment.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations. For example, one or more of the models described herein may be trained to generate recommendations based on communication content derived from a group communication session and/or contextual data collected associated with the group communication session and/or participants thereof, and such recommendations can be used to initiate one or more automated actions (e.g., automatically outputting modified communication content to one or more participants in the group communication session, automatically training artificial intelligence techniques, etc.).

The techniques depicted in FIG. 8 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 8 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as communication content modification code 926. In addition to code 926, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and code 926, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

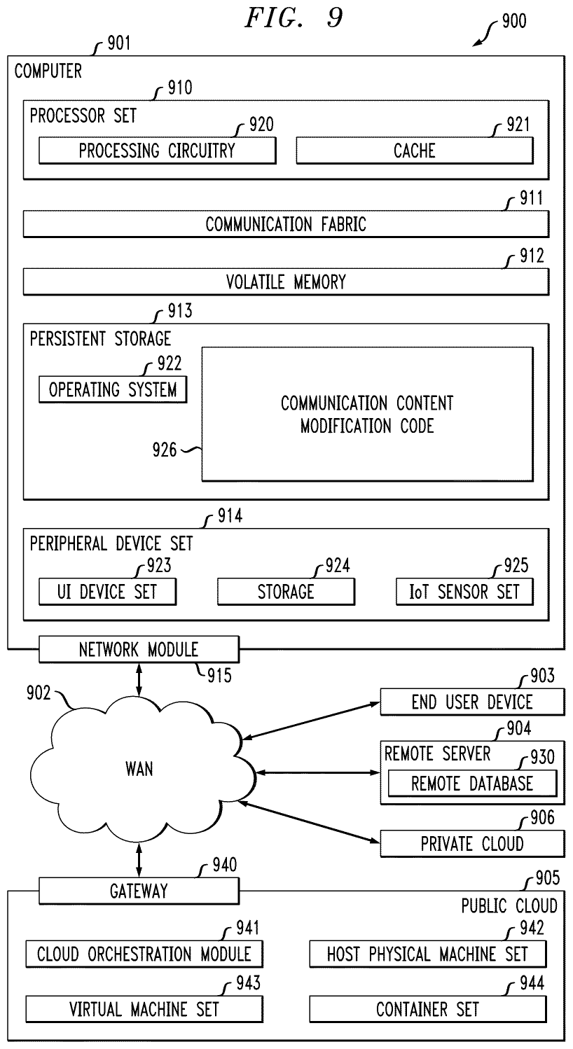

Computer 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

Processor set 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in code 926 in persistent storage 913.

Communication fabric 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 912 is any type of volatile memory now known or to be developed in the future. Examples include dynamic type RAM or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

Persistent storage 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a ROM, but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in code 926 typically includes at least some of the computer code involved in performing the inventive methods.

Peripheral device set 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

Network module 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

Remote server 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

Public cloud 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

In computing environment 900, computer 901 is shown as being connected to the internet (see WAN 902). However, in many embodiments of the present invention computer 901 will be isolated from communicating over communications network and not connected to the internet, running as a standalone computer. In these embodiments, network module 915 of computer 901 may not be necessary or even desirable in order to ensure isolation and to prevent external communications coming into computer 901. The standalone computer embodiments are potentially advantageous, at least in some applications of the present invention, because they are typically more secure. In other embodiments, computer 901 is connected to a secure WAN or a secure LAN instead of WAN 902 and/or the internet. In these network connected (that is, not standalone) embodiments, the system designer may want to take appropriate security measures, now known or developed in the future, to reduce the risk that incoming network communications do not cause a security breach.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory configured to store program instructions; and
a processor operatively coupled to the memory to execute the program instructions to:
identify one or more portions of communication content within a group communication session to be modified by processing the communication content and one or more items of contextual information associated with the group communication session;
generate at least one item of modified communication content related to at least a portion of the one or more identified portions of communication content by processing the one or more identified portions of communication content using one or more artificial intelligence techniques; and
perform one or more automated actions based at least in part on the at least one item of modified communication content.

2. The system of claim 1, wherein processing the one or more identified portions of communication content using one or more artificial intelligence techniques comprises processing the one or more identified portions of communication content using one or more natural language processing techniques.

3. The system of claim 2, wherein using one or more natural language processing techniques comprises using one or more natural language processing techniques in conjunction with at least one chatbot.

4. The system of claim 1, wherein processing the one or more identified portions of communication content using one or more artificial intelligence techniques comprises processing the one or more identified portions of communication content using one or more deep reinforcement learning techniques.

5. The system of claim 1, wherein performing one or more automated actions comprises automatically outputting the at least one item of modified communication content to one or more participants in the group communication session.

6. The system of claim 1, wherein performing one or more automated actions comprises automatically training at least a portion of the one or more artificial intelligence techniques using feedback related to the at least one item of modified communication content.

7. The system of claim 1, wherein generating at least one item of modified communication content comprises using at least one knowledge graph in conjunction with the one or more artificial intelligence techniques, wherein using the at least one knowledge graph comprises adjusting weights of one or more nodes of the at least one knowledge graph based at least in part on one or more speaker sentiments associated with the one or more identified portions of communication content.

8. The system of claim 1, wherein generating at least one item of modified communication content comprises assigning one or more vectors to the one or more identified portions of communication content and ranking, using the one or more vectors, each of the one or more identified portions of communication content based at least in part on proximity to one or more topics associated with the group communication session.

9. The system of claim 1, wherein identifying one or more portions of communication content within a group communication session to be modified comprises determining, for each of multiple portions of the communication content, at least one degree of proximity relative to at least one topic associated with the communication content.

10. The system of claim 1, wherein identifying one or more portions of communication content within a group communication session to be modified comprises processing the communication content against one or more predetermined factors associated with ambiguous communication content, wherein the one or more predetermined factors comprise at least one of usage of one or more words being associated with multiple meanings, speed of speech exceeding a predetermined threshold, and usage of a number of words exceeding a predetermined threshold amount.

11. The system of claim 1, wherein identifying one or more portions of communication content within a group communication session to be modified comprises comparing one or more amplitude of sound associated with the communication content against at least one predetermined threshold.

12. The system of claim 1, wherein identifying one or more portions of communication content within a group communication session to be modified comprises filtering the communication content using one or more predetermined keywords associated with ambiguity.

13. A computer program product comprising a computer readable storage medium having program instructions embodied therewith, the program instructions executable by a computing device to cause the computing device to:
identify one or more portions of communication content within a group communication session to be modified by processing the communication content and one or more items of contextual information associated with the group communication session;
generate at least one item of modified communication content related to at least a portion of the one or more identified portions of communication content by processing the one or more identified portions of communication content using one or more artificial intelligence techniques; and
perform one or more automated actions based at least in part on the at least one item of modified communication content.

14. The computer program product of claim 13, wherein processing the one or more identified portions of communication content using one or more artificial intelligence techniques comprises processing the one or more identified portions of communication content using one or more natural language processing techniques.

15. The computer program product of claim 13, wherein processing the one or more identified portions of communication content using one or more artificial intelligence techniques comprises processing the one or more identified portions of communication content using one or more deep reinforcement learning techniques.

16. The computer program product of claim 13, wherein performing one or more automated actions comprises automatically outputting the at least one item of modified communication content to one or more participants in the group communication session.

17. A computer-implemented method comprising:
identifying one or more portions of communication content within a group communication session to be modified by processing the communication content and one or more items of contextual information associated with the group communication session;
generating at least one item of modified communication content related to at least a portion of the one or more identified portions of communication content by processing the one or more identified portions of communication content using one or more artificial intelligence techniques; and
performing one or more automated actions based at least in part on the at least one item of modified communication content;
wherein the method is carried out by at least one computing device.

18. The computer-implemented method of claim 17, wherein processing the one or more identified portions of communication content using one or more artificial intelligence techniques comprises processing the one or more identified portions of communication content using one or more natural language processing techniques.

19. The computer-implemented method of claim 17, wherein processing the one or more identified portions of communication content using one or more artificial intelligence techniques comprises processing the one or more identified portions of communication content using one or more deep reinforcement learning techniques.

20. The computer-implemented method of claim 17, wherein software implementing the method is provided as a service in a cloud environment.
